(19) United States
(12) Patent Application Publication
(10) Pub. No.: US 2007/0140264 A1
(43) Pub. Date: Jun. 21, 2007

(54) ADDRESS TRANSLATION DEVICE AND METHOD FOR FORWARDING PACKETS FOR THE SAME

(75) Inventors: PIN-WEN CHEN, Shenzhen (CN); JENG-SEN LIN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,440

(22) Filed: Aug. 4, 2006

(30) Foreign Application Priority Data
Dec. 20, 2005 (CN) 200510121034.7

(51) Int. Cl. H04L 12/56

(52) U.S. Cl. 370/395.54; 370/466

(57) ABSTRACT

An address translation device includes a connection searching module, a table creation module, a media access control (MAC) address searching module, and a forwarding module. The connection searching module receives a packet, and searches a connection mapping table according to the packet. The connection mapping table includes a plurality of connection entries, and each connection entry includes a routing entry. The connection searching module further determines whether a connection entry with a connection matching that of the packet is found in the connection mapping table. The table creation module creates a connection entry in the connection mapping table, and creates a routing entry in the connection entry. The MAC address searching module acquires a destination MAC address from the routing entry of the connection entry in the connection mapping table. The forwarding module adds the acquired destination MAC address to the packet, and forwards the packet.

### FIELD OF THE INVENTION

The invention relates to network communications, and particularly to an address translation device and a method for forwarding packets.

### DESCRIPTION OF RELATED ART

Due to rapid developments in the Internet technology, hosts using Internet protocol (IP) addresses have increased, resulting in a lack of IP addresses. Accordingly, network address translation (NAT) devices are introduced to resolve the problem.

However, central processing units (CPUs) of traditional NAT devices are low-grade because of cost restrictions. Therefore, speed of forwarding packets of the traditional NAT devices is often very slow.

FIG. 1 is a schematic diagram of functional modules of a traditional NAT device 10. In the traditional NAT device 10, the forwarding procedure of packets is as follows: receiving the packets via a local area network (LAN) interface 11; processing the packets by an IP stack module 12; processing the packets by an NAT kernel module 13; and forwarding the packets via a wide area network (WAN) interface 14.

In the forwarding procedure of the traditional NAT device 10, because each packet needs to be processed by the IP stack module 12, the IP stack module 12 is highly loaded when processing the packets, resulting in a bottleneck and slowing the speed of the forwarding process. Moreover, the processing speed of the CPU of the traditional NAT device 10 is slow, so the forwarding efficiency of the traditional NAT device 10 is also slow.

### SUMMARY OF THE INVENTION

An exemplary embodiment of the present invention provides an address translation device for forwarding packets. The address translation device includes a connection searching module, a table creation module, a media access control (MAC) address searching module, and a forwarding module. The connection searching module receives a packet, and searches a connection mapping table according to the packet. The connection mapping table includes a plurality of connection entries, and each connection entry includes a routing entry. The connection searching module further determines whether a connection entry with a connection matching that of the packet is found in the connection mapping table. The table creation module creates a connection entry of the packet in the connection mapping table, and creates a routing entry in the connection entry of the packet. The MAC address searching module acquires a destination MAC address from the routing entry of the connection entry in the connection mapping table. The forwarding module adds the acquired destination MAC address to the packet, and forwards the packet.

Another exemplary embodiment of the present invention provides a method for forwarding packets. The method includes the steps of: providing a connection mapping table including a plurality of connection entries, wherein each connection entry includes a routing entry; receiving a packet; searching the connection mapping table according to the packet; determining whether a connection entry with a connection matching that of the packet is found in the connection mapping table; acquiring a destination MAC address from the routing entry of the connection entry if the connection entry with a matching connection is found; adding the acquired destination MAC address to the packet; and forwarding the packet.

Other advantages and novel features will become more apparent from the following detailed description when taken in conjunction with the accompanying drawings, in which:

### BRIEF DESCRIPTION OF THE DRAWINGS

FIG. 1 is a schematic diagram of functional modules of a traditional network address translation (NAT) device;

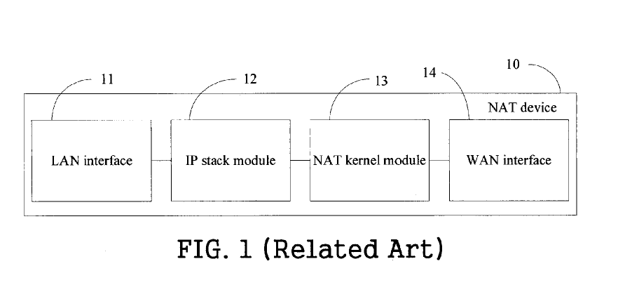

FIG. 2 is a schematic diagram of a network communication system of an exemplary embodiment of the present invention;

FIG. 3 is a schematic diagram of functional modules of an address translation device of another exemplary embodiment of the present invention;

FIG. 4 is a flowchart of a method for forwarding packets of a further exemplary embodiment of the present invention, wherein the method includes a method for creating a routing entry; and

FIG. 5 is a flowchart of the method for creating a routing entry of FIG. 4.

### DETAILED DESCRIPTION OF THE INVENTION

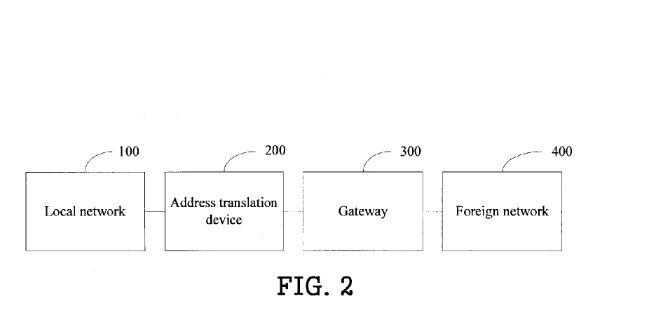

FIG. 2 is a schematic diagram of a network communication system of an exemplary embodiment of the present invention. In the exemplary embodiment, the network communication system includes a local network 100, an address translation device 200, a gateway 300, and a foreign network 400. The address translation device 200 may be a network address translation (NAT) device, a firewall, an Internet protocol (IP) sharing device, or another device translating IP addresses by use of software. The gateway 300 is a default gateway.

In the exemplary embodiment, the address translation device 200 can forward packets to the local network 10, and can also forward packets between the local network 100 and the foreign network 400 via the gateway 300. When forwarding packets, the address translation device 200 establishes a connection mapping table. The connection mapping table includes a plurality of connection entries, and each connection entry includes a routing entry. In the exemplary embodiment, the connection entry includes a source IP address, a source port, a destination IP address, a destination port, and a routing entry. The routing entry includes a destination media access control (MAC) address and a destination interface.

In other embodiments, the connection entry may further include modified IP, modified port, transport control port (TCP), user datagram protocol (UDP), Internet control message protocol (ICMP), inbound/outbound information or other relevant connection information. The routing entry may include more relevant routing information.

In the exemplary embodiment, when forwarding a first packet, the address translation device 200 creates a connection entry of the first packet in the connection mapping table. That is, the address translation device 200 records a source IP address, a source port, a destination IP address, and a destination port of the first packet in the connection entry. In addition, the address translation device 200 creates a routing entry of the first packet in the connection entry. That is, the address translation device 200 records a destination MAC address and a destination interface of the first packet in the routing entry of the connection entry. Then, when the address translation device 200 receives further packets with connections matching that of the first packet, the address translation device 200 can rapidly forward these further packets according to the routing entry in the connection mapping table. In the exemplary embodiment, packets with the matching connections include the same source IP addresses, the same destination IP addresses, and the same destination ports. In other embodiment, the packets with the matching connections may include more same connection information according to different acquirements.

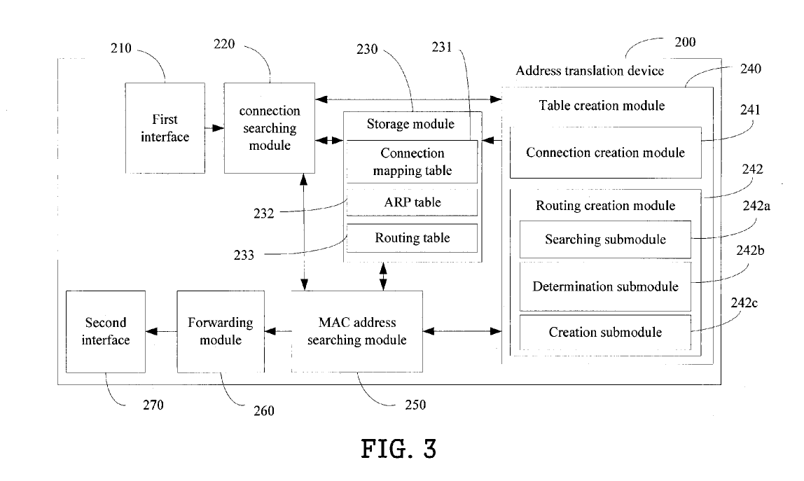

FIG. 3 is a schematic diagram of functional modules of the address translation device 200 of an exemplary embodiment of the present invention. In the exemplary embodiment, the address translation device 200 includes a first interface 210, a connection searching module 220, a storage module 230, a table creation module 240, an MAC address searching module 250, a forwarding module 260, and a second interface 270.

The storage module 230 stores a connection mapping table 231, an address resolution protocol (ARP) table 232, and a routing table 233. The connection mapping table 231 includes a plurality of connection entries, and each connection entry includes a routing entry. The ARP table 232 indicates a relation between a destination IP address and a destination MAC address of the packet. The routing table 233 provides routing information including a route parameter. The first interface 210 receives a packet from the local network 100, or from the foreign network 400 via the gateway 300. The connection searching module 220 receives the packet via the first interface 210, searches the connection mapping table 231 of the storage module 230 according to the packet, and determines whether a connection entry with a connection matching that of the packet is found.

If a connection entry with a connection matching that of the packet is not found, the table creation module 240 creates a connection entry of the packet in the connection mapping table 231, and creates a routing entry in the connection entry of the packet. In the exemplary embodiment, the table creation module 240 includes a connection creation module 241 and a routing creation module 242. The connection creation module 241 creates the connection entry of the packet in the connection mapping table 231. The connection entry created by the connection creation module 241 includes a null routing entry. The routing creation module 242 creates the routing entry in the connection entry of the packet.

In the exemplary embodiment, the routing creation module 242 includes a searching submodule 242a, a determination submodule 242b, and a creation submodule 242c. The searching submodule 242a searches for the routing entry of the packet in the routing table 233 according to a destination IP address thereof, and acquires a route parameter from the routing table 133. That is, the searching submodule 242a searches for a destination MAC address and a destination interface of the packet. The searching submodule 242a further transmits the route parameter to the determination submodule 242b. The determination submodule 242b determines whether a route of the packet is a direct route according to the route parameter. The creation submodule 242c creates the routing entry in the connection entry of the packet, according to the searched result of the searching submodule 242a and the determination result of the determination submodule 242b.

In the exemplary embodiment, the route parameter indicates whether the route of the packet is a direct route or an indirect route. If the route parameter indicates that the route of the packet is a direct route, the packet does not need to be forwarded via the gateway 300. If the route parameter indicates that the route of the packet is an indirect route, the packet needs to be forwarded via the gateway 300. Therefore, if the route of the packet is a direct route, the searching submodule 242a creates the routing entry in the connection entry of the packet. The routing entry includes an MAC address and a destination interface. If the route of the packet is an indirect route, the searching submodule 242a further searches for a different routing entry by using the gateway 300 as a destination IP address. The creation submodule 242c then creates the different routing entry in the connection entry of the packet. In the exemplary embodiment, the different connection entry includes a destination MAC address matching with a port connected to the gateway 300 and a destination interface connected to the gateway 300.

If a connection entry with a connection matching that of the packet is found, the MAC address searching module 250 acquires a destination MAC address of the packet from a routing entry of the connection entry. The MAC address searching module 250 further determines whether the destination MAC address is valid, and searches a valid destination MAC address if the destination MAC address is invalid. In the exemplary embodiment, four requirements must be satisfied to validate the destination MAC address. Firstly, the length of the destination MAC address cannot be zero. Secondly, the destination interface must be valid. Thirdly, the first interface 210 and the second interface 270 must be in connection. Fourthly, the ARP table 232 cannot be amended.

If the destination MAC address is invalid, the MAC address searching module 250 further determines whether the ARP table 232 is amended.

If the ARP table 232 is not amended, the MAC address searching module 250 searches for a valid destination MAC address of the packet in the routing table 233, according to the destination IP address of the packet. If the ARP table 232 is amended, the routing entry of the connection entry of the packet is invalid. In such case, the routing creation module 242 creates a routing entry in the connection entry of the packet again. Then the MAC address searching module 250 searches for a valid destination MAC address of the packet in the routing table 233 according to the destination IP address of the packet, and acquires the valid destination MAC address.

The forwarding module 260 adds the valid destination MAC address to the packet, and forwards the packet via the second interface 270.

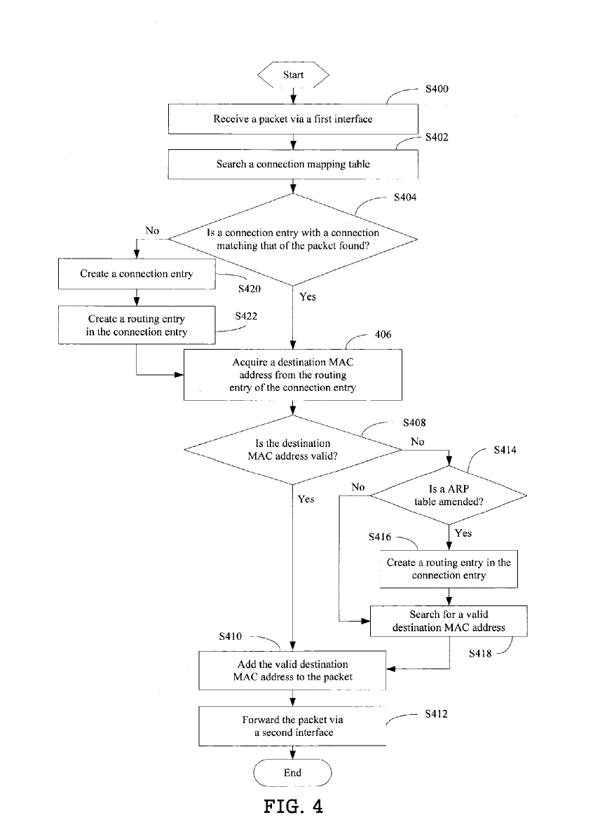

FIG. 4 is a flowchart of a method for forwarding packets of an exemplary embodiment of the present invention. In the exemplary embodiment, the address translation device 200 forwards a packet in the local network 100, or forwards a packet between the local network 100 and the foreign network 400 via the gateway 300.

In step S400, the address translation device 200 receives a packet via the first interface 210.

In step S402, the connection searching module 220 searches the connection mapping table 231 of the storage module 230 according to the received packet, in order to find a connection entry with a connection matching that of the packet.

In step S404, the connection searching module 220 determines whether a connection entry with a connection matching that of the packet is found in the connection mapping table 231.

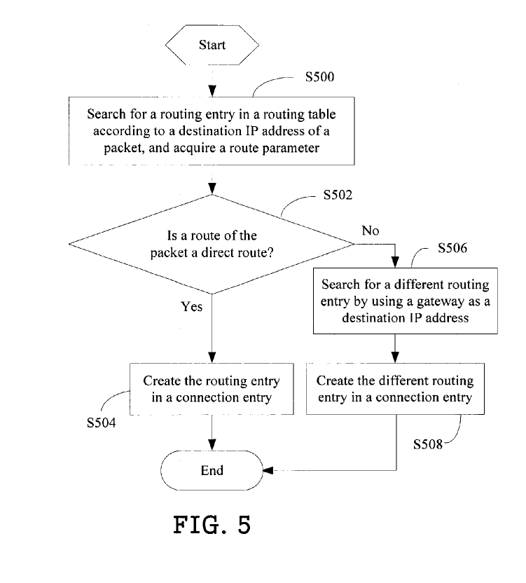

If no connection entry with a connection matching that of the packet is found in the connection mapping table 231, in step S420, the connection creation module 241 of the table creation module 240 creates a connection entry of the packet in the connection mapping table 231. Then, in step S422, the routing creation module 242 of the table creation module 240 creates a routing entry in the connection entry of the packet. The details of the method for creating the routing entry by the routing creation module 242 are described in FIG. 5.

If a connection entry with a connection matching that of the packet is found in the connection mapping table 231, in step S406, the MAC address searching module 250 acquires a destination MAC address from the routing entry of the connection entry.

In step S408, the MAC address searching module 250 determines whether the destination MAC address is valid. In the exemplary embodiment, four requirements must be satisfied to validate the destination MAC address. Firstly, the destination MAC address cannot be zero. Secondly, the destination interface of the packet must be valid. Thirdly, the first interface 210 and the second interface 270 must be in connection. Fourthly, the ARP table 232 cannot be amended.

If the destination MAC address is invalid, in step S414, the MAC address searching module 250 determines whether the ARP table 232 is amended.

If the ARP table 232 is amended, the routing entry of the connection entry is invalid. In such case, in step S416, the routing creation module 242 creates a routing entry in the connection entry of the packet. Then the procedure goes to step S418.

If the ARP table 232 is not amended, in step S418, the MAC address searching module 250 searches for a valid destination MAC address of the packet. In the exemplary embodiment, the MAC address searching module 250 searches for the valid destination MAC address of the packet in the routing table 233 according to the destination IP address of the packet. Then the procedure goes to step S410.

If the destination MAC address is valid, in step S410, the forwarding module 260 adds the valid destination MAC address to the packet. In step S412, the forwarding module 260 forwards the packet via the second interface 270.

FIG. 5 is a flowchart of a method for creating a routing entry of an exemplary embodiment of the present invention, namely the detailed flowchart of steps S422 and S416 in FIG. 4. In the exemplary embodiment, the address translation device 200 creates a routing entry in a connection entry.

In step S500, the searching submodule 242a of the routing creation module 242 searches for the routing entry of the packet in the routing table 233 according to the destination IP address of the packet, and acquires a route parameter from the routing table 233. In the exemplary embodiment, the searching submodule 242a searches for a destination MAC address and a destination interface of the packet in the routing table 233. The searching submodule 242 further transmits the route parameter to the determination submodule 242b of the routing creation module 242.

In step S502, the determination submodule 242b determines whether a route of the packet is a direct route according to the route parameter. In the exemplary embodiment, the route parameter indicates the route of the packet is a direct route or an indirect route. If the route parameter indicates the route of the packet is a direct route, the packet does not need to be forwarded via the gateway 300. If the route parameter indicates the route of the packet is an indirect route, the packet needs to be forwarded via the gateway 300.

If the route of the packet is a direct route, in step S504, the creation submodule 242c of the routing creation module 242 creates the routing entry in the connection entry. That is, the creation submodule 242c records a destination MAC address and a destination interface of the packet in the routing entry.

If the route of the packet is an indirect route, in step S506, the searching submodule 242a further searches for a different routing entry by using the gateway 300 as a destination IP address. In step S508, the creation submodule 242c of the routing creation module 242 creates the different routing entry in the connection entry. In the exemplary embodiment, the different connection entry includes a destination MAC address matching a port connected to the gateway 300 and a destination interface connected to the gateway 300.

In the exemplary embodiment of the present invention, the address translation device 200 creates a routing entry of a first packet in connection mapping table 231. Further packets are received for forwarding with connections matching that of the first packet, the address translation device 200 can promptly acquire a destination MAC address and a destination interface of the further packets from the routing entry of the first packet, and rapidly forward the further packets according to the acquired destination MAC address. Therefore, the forwarding efficiency of the address translation device 200 is improved.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An address translation device for forwarding packets, comprising:
a connection searching module, for receiving a packet, and searching a connection mapping table according to the packet, the connection mapping table comprising a plurality of connection entries, each connection entry comprising a routing entry; and the connection searching module further determining whether a connection entry with a connection matching that of the packet is found in the connection mapping table;
a table creation module, for creating a connection entry of the packet in the connection mapping table, and creating a routing entry in the connection entry of the packet;
a media access control (MAC) address searching module, for acquiring a destination MAC address from the routing entry of the connection entry in the connection mapping table; and
a forwarding module, for adding the acquired destination MAC address to the packet, and forwarding the packet.

2. The address translation device as claimed in claim 1, wherein the MAC address searching module is further used for determining whether the destination MAC address is valid, and searching for a valid destination MAC address if the destination MAC address is invalid.

3. The address translation device as claimed in claim 1, wherein the routing entry comprises the destination MAC address and a destination interface of the packet.

4. The address translation device as claimed in claim 1, wherein the connection entry further comprises a source Internet protocol (IP) address, a source port, a destination IP address, and a destination port of the packet.

5. The address translation device as claimed in claim 1, further comprising a storage module, for storing the connection mapping table, an address resolution protocol (ARP) table, and a routing table.

6. The address translation device as claimed in claim 5, wherein the table creation module includes a connection creation module for creating the connection entry of the packet in the connection mapping table and a routing creation module for creating the routing entry in the connection entry of the packet.

7. The address translation device as claimed in claim 6, wherein the routing creation module comprises a searching submodule, for searching for the routing entry of the packet in the routing table according to a destination Internet protocol address of the packet, and acquiring a route parameter from the routing table.

8. The address translation device as claimed in claim 7, wherein the routing creation module further comprises a determination submodule, for determining whether a route of the packet is a direct route according to the route parameter.

9. The address translation device as claimed in claim 8, wherein the routing creation module further comprises a creation submodule, for creating the routing entry in the connection entry of the packet, according to the searched result of the searching submodule and the determination result of the determination submodule.

10. A method for forwarding packets comprising steps of:
providing a connection mapping table comprising a plurality of connection entries, wherein each connection entry comprises a routing entry;
receiving a packet;
searching the connection mapping table according to the packet;
determining whether a connection entry with a connection matching that of the packet is found in the connection mapping table;
acquiring a destination media access control (MAC) address from the routing entry of the connection entry if the connection entry with a matching connection is found;
adding the destination MAC address to the packet; and
forwarding the packet.

11. The method as claimed in claim 10, wherein the routing entry comprises the destination MAC address and a destination interface of the packet.

12. The method as claimed in claim 10, wherein the connection entry further comprises a source Internet protocol (IP) address, a source port, a destination IP address, and a destination port of the packet.

13. The method as claimed in claim 10, further comprising steps of:
creating a connection entry of the packet in the connection mapping table, if no connection entry with a matching connection is found; and
creating a routing entry in the connection entry of the packet.

14. The method as claimed in claim 13, wherein the step of creating a routing entry in the connection entry of the packet comprises steps of:
searching for the routing entry of the packet in a routing table according to a destination Internet protocol address of the packet, and acquiring a route parameter from the routing table;
determining whether a route of the packet is a direct route according to the route parameter; and
creating the routing entry in the connection entry of the packet, if the route of the packet is a direct route.

15. The method as claimed in claim 14, wherein the step of creating a routing entry in the connection entry of the packet further comprises steps of:
providing a gateway; and
searching for a routing entry of the packet by using the gateway as a destination Internet protocol address, if the route of the packet is an indirect route.

16. The method as claimed in claim 10, further comprising steps of:
determining whether the destination MAC address is valid; and
adding the destination MAC address to the packet and forwarding the packet, if the destination MAC address is valid.

17. The method as claimed in claim 16, further comprising steps of:
providing an address resolution protocol (ARP) table;
determining whether the ARP table is amended, if the destination MAC address is invalid;
searching for a valid destination MAC address of the packet, if the ARP table is not amended; and
creating the routing entry in the connection entry of the packet, if the ARP table is amended.

18. The method as claimed in claim 17, wherein the step of creating the routing entry in the connection entry of the packet comprises steps of:
searching for a routing entry of the packet in a routing table according to a destination Internet protocol address of the packet, and acquiring a route parameter from a routing table;
determining whether a route of the packet is a direct route according to the route parameter; and
creating the routing entry in the connection entry of the packet, if the route of the packet is a direct route.

19. The method as claimed in claim 18, wherein the step of creating the routing entry in the connection entry of the packet further comprises steps of:
providing a gateway; and
searching for a routing entry of the packet by using the gateway as a destination Internet protocol address if the route of the packet is an indirect route.

20. A method for forwarding packets comprising steps of:
establishing a connection mapping table to record a plurality of connection entries comprising a corresponding routing entry therein respectively based on finished packet-forwarding;
receiving a packet;
verifying a connection of said packet to determine availability of a matching connection entry out of said plurality of connection entries from said connection mapping table;
forwarding said packet by means of using said corresponding routing entry when said matching connection entry is available from said connection mapping table; and
creating another connection entry in said connection mapping table based on said connection of said packet after forwarding said packet when said matching connection entry is not available from said connection mapping table.
